(19) United States
(12) Patent Application Publication
(10) Pub. No.: US 2026/0054424 A1
(43) Pub. Date: Feb. 26, 2026

(54) Additive manufacturing method based on modular precision mold units

(71) Applicant: Xinming LU, Suzhou (CN)

(72) Inventor: Xinming LU, Suzhou (CN)

(21) Appl. No.: 19/307,037

(22) Filed: Aug. 22, 2025

(30) Foreign Application Priority Data
Aug. 23, 2024 (CN) 202411163906.5

(51) Int. Cl. B29C 33/30; B29C 33/38; B29C 64/393; B29C 64/40; B33Y 10/00; B33Y 40/20; B33Y 50/02; B33Y 80/00

(52) U.S. Cl. CPC B29C 33/301; B29C 33/3892; B29C 64/393; B29C 64/40; B33Y 10/00; B33Y 40/20; B33Y 50/02; B33Y 80/00

(57) ABSTRACT

The present disclosure belongs to the technical field of additive manufacturing (AM), and specifically relates to an AM method based on modular precision mold units. The method includes: slicing a digital model of a target three-dimensional (3D) component; manufacturing separated mold unit blanks, each including a sacrificial material pattern layer and an encapsulating mold material layer; performing precision machining; forming an integrated combined mold through stacking; removing a sacrificial material to form a cavity; injecting a material; and removing a mold after curing of the material to obtain a target component. Alternatively, the method includes: acquiring a model slice; manufacturing temporary mold units, each including a negative pattern; directly filling a final component material; performing precision machining; stacking; implementing curing and connection to form an integrated whole; and removing a temporary mold to obtain a target component. The method of the present disclosure eliminates error accumulation through modular precision machining, enabling low-cost and efficient manufacturing of large-sized, high-precision, and complex structural components.

### CROSS-REFERENCE TO THE RELATED APPLICATIONS

The present application claims priority to Chinese Patent Application 202411163906.5, filed on Aug. 23, 2024, and entitled “HIGH-PRECISION MANUFACTURING METHOD FOR LARGE-SIZED THREE-DIMENSIONAL LATTICE COMPONENT”, which is incorporated herein by reference in its entirety.

### TECHNICAL FIELD

The present disclosure belongs to the technical field of additive manufacturing (AM), and relates to an AM method based on modular precision mold units, in particular to an indirect AM method for manufacturing a large-sized, high-precision component with a complex internal structure by constructing a high-precision integrated mold through independent manufacturing, precision machining, and stacking of modular mold units.

### BACKGROUND TECHNOLOGY

Commonly known as three-dimensional (3D) printing, AM technologies construct 3D components through layer-by-layer material deposition, bringing revolutionary breakthroughs to the design and manufacturing of complex structures. However, existing AM technologies still face severe challenges when applied to the industrial production of large-sized, high-precision components.

Direct metal AM technologies, such as selective laser melting (SLM) or electron beam melting (EBM), can manufacture high-performance metal components but suffer from issues such as high equipment costs, slow manufacturing speeds, and expensive raw materials. More importantly, when large-sized components are constructed, repeated thermal cycles can easily lead to internal stress accumulation and warping deformation, making it hard to control the final dimensional precision and resulting in significant cumulative errors.

To reduce costs, some indirect AM methods have been proposed in the industry. They share a common feature in that they do not directly print the final product but first construct a temporary structure and then obtain the final component through filling, casting, etc. However, existing indirect manufacturing methods still inherit the inherent limitations of traditional AM in precision control. That is, due to the adoption of a continuous, integrated stacking method, minor errors in the manufacturing process accumulate layer by layer, resulting in that a larger component size leads to worse final geometric tolerance. Therefore, existing indirect manufacturing methods cannot meet the requirements for high-precision large-sized components in fields such as aerospace and precision molds.

### CONTENT OF THE INVENTION

In view of the deficiencies of the prior art, the present disclosure provides an AM method based on modular precision mold units. The present disclosure decomposes the overall manufacturing process into two independent stages: mold unit manufacturing and machining, and integrated mold assembly. In this way, the present disclosure eliminates error accumulation and can efficiently manufacture large-sized, high-precision complex components at a low cost.

The AM method based on modular precision mold units provided by the present disclosure includes following steps:
a) slicing a digital model of a target 3D component to generate a series of two-dimensional (2D) cross-sectional data;
b) manufacturing a series of physically separated mold unit blanks according to the 2D cross-sectional data, where each of the mold unit blanks includes a pattern layer made of a sacrificial material and a mold material layer encapsulating the pattern layer;
c) performing precision machining on each of the mold unit blanks to achieve surface correction, and obtaining a series of finished mold units;
d) precisely aligning and stacking the series of finished mold units according to an original slicing sequence, and forming an integrated combined mold;
e) removing the sacrificial material from the integrated combined mold, and forming a mold cavity; and
f) introducing a material of the target component into the mold cavity for curing, removing the mold material after curing, and obtaining the target 3D component.

In a further optimized solution of the AM method, the step c) includes: performing precision machining on at least one reference surface on two sides of the mold unit blank to control flatness of the reference surface and/or a thickness of the mold unit blank.

In a further optimized solution of the AM method, the precision machining is milling, grinding, planing, laser machining, plasma machining, or waterjet machining.

In a further optimized solution of the AM method, the sacrificial material is a thermally sensitive material or a solvent-sensitive material.

In a further optimized solution of the AM method, the thermally sensitive material is selected from water, paraffin wax, Fischer-Tropsch wax, polyethylene wax, or a low-melting-point alloy.

In a further optimized solution of the AM method, the solvent-sensitive material is selected from a polyvinyl alcohol, a soluble acrylic resin, or a salt.

In a further optimized solution of the AM method, the mold material is a high-temperature-resistant material selected from a gypsum-based composite material, a cement-based composite material, or a mixture including ceramic powder and a binder.

In a further optimized solution of the AM method, the step b) includes: forming the pattern layer made of the sacrificial material by a method selected from screen printing, inkjet printing, or fused deposition.

In a further optimized solution of the AM method, the target 3D component is a 3D component with an internal lattice structure.

In a further optimized solution of the AM method, the method further includes: assembling multiple integrated combined molds formed according to the step d) as sub-modules to form a larger composite mold for manufacturing the target 3D component exceeding a size range of a single integrated combined mold.

The present disclosure further provides another AM method based on modular precision mold units, including following steps:
a) obtaining and slicing a digital model of a target 3D component into a series of 2D cross-sectional data;
b) manufacturing a series of layered temporary mold units according to the 2D cross-sectional data, where the temporary mold units are formed by depositing a temporary material on a flat substrate, and the deposited temporary material forms a negative pattern complementary in shape and consistent in contour with the 2D cross-sectional data;
c) filling a final component material into a negative pattern cavity of each mold unit;
d) performing independent precision machining on each mold unit filled with the final material to achieve thickness and flatness correction of the mold unit;
e) precisely aligning and stacking the precision-machined mold units according to an original slicing sequence;
f) curing the final component material, and connecting the final component material into an integrated whole; and
g) removing the temporary mold units to obtain the target 3D component.

In a further optimized solution of the AM method, in the step c), the final component material is selected from flowable powder, slurry formed by mixing powder with a binder, a molten metal, plastic or ceramic fluid, or a reactively formable fluid.

In a further optimized solution of the AM method, the final component material is filled by a method selected from pipe conveying, nozzle spraying, electrostatic, chemical or physical adsorption, or laser or plasma coating.

In a further optimized solution of the AM method, the step g) includes: selectively removing the temporary material under a preset condition selected from heating, cooling, dissolution, chemical reaction, or mechanical peeling.

In a further optimized solution of the AM method, there is a separable interface characteristic between the temporary mold unit and the target component, enabling the removal of the temporary material to be completed without damaging the target component.

### Beneficial Effects

Compared with the prior art, the AM method based on modular precision mold units provided by the present disclosure has significant advantages. The present disclosure performs precision machining on each independent and physically separated mold unit. Thus, the present disclosure effectively decomposes the macroscopic cumulative error problem into a microscopic, controllable unit precision problem, fundamentally ensuring the global high precision of the final large-sized component and achieving high-precision control. Meanwhile, the present disclosure can use low-cost materials to manufacture mold units in parallel, significantly reducing raw materials and time costs. Compared to large metal 3D printers that often cost millions or even tens of millions, the present disclosure achieves a higher return on investment, demonstrating outstanding economy and efficiency. Furthermore, the present disclosure inherits the advantages of AM in manufacturing complex structures and can easily realize the construction of arbitrarily complex internal structures. Besides, by virtue of its modular characteristics, the present disclosure possesses unlimited size expansion capability, can break through the size limitations of conventional manufacturing equipment, and provides a feasible path for the manufacturing of ultra-large-sized complex components.

### DESCRIPTION OF THE DRAWINGS

FIG. 1 is a structural view of a target component in a first embodiment of the present disclosure;

FIG. 2 is a 2D cross-sectional view of the target component after slicing in the first embodiment of the present disclosure;

FIG. 3 is a schematic diagram of manufacturing a sacrificial material pattern layer through a screen printing process in the first embodiment of the present disclosure;

FIG. 4 is a schematic diagram of manufacturing a sacrificial material pattern layer through dispensing by a movable hopper in the first embodiment of the present disclosure;

FIG. 5 is a schematic diagram of encapsulating the pattern layer by a spraying device in the first embodiment of the present disclosure;

FIG. 6 is a schematic diagram of machining a reference surface of a unit blank by a precision machining device in the first embodiment of the present disclosure;

FIG. 7 is a structural view of a finished unit obtained by precision machining in the first embodiment of the present disclosure;

FIG. 8 is a structural view of an integrated combined mold obtained by stacking in the first embodiment of the present disclosure;

FIG. 9 is a schematic diagram of injecting a material melt of a final product into a mold cavity in the first embodiment of the present disclosure;

FIG. 10 is a schematic diagram of assembling multiple molds as sub-modules in the first embodiment of the present disclosure;

FIG. 11 is a structural view of a target component in a second embodiment of the present disclosure;

FIG. 12 is a schematic diagram of a positive pattern generated by slicing and a complementary negative pattern thereof in the second embodiment of the present disclosure;

FIG. 13 is a schematic diagram of filling a final component material into a temporary mold unit cavity in the second embodiment of the present disclosure;

FIG. 14 is a structural view of a finished unit obtained in the second embodiment of the present disclosure; and

FIG. 15 is a structural view of a final target component obtained in the second embodiment of the present disclosure.

### SPECIFIC IMPLEMENTATIONS

The following specific embodiments further elucidate the present disclosure. These embodiments are exemplary, intended to illustrate and explain the present disclosure, and should not be construed as a limitation.

### Embodiment 1

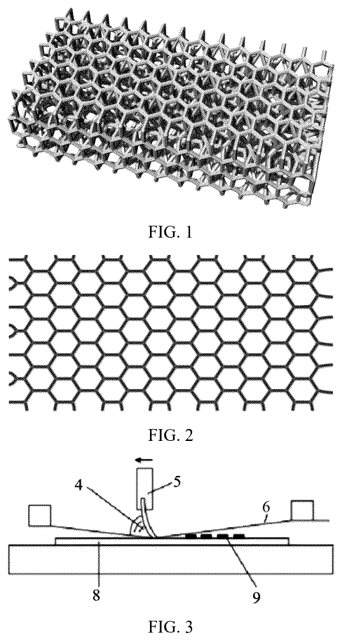

In this embodiment, the manufacturing of a large-sized 3D lattice component shown in FIG. 1 is taken as an example to describe an AM method based on modular precision mold units. As a target component, the 3D lattice component is integrally formed by multiple connection nodes and rod-shaped members connected together.

Specifically, a slicing process is performed on a 3D digital model of the product shown in FIG. 1 to generate a series of 2D cross-sectional patterns, as shown in FIG. 2. The collection of these patterns completely records the 3D geometric shape of the product.

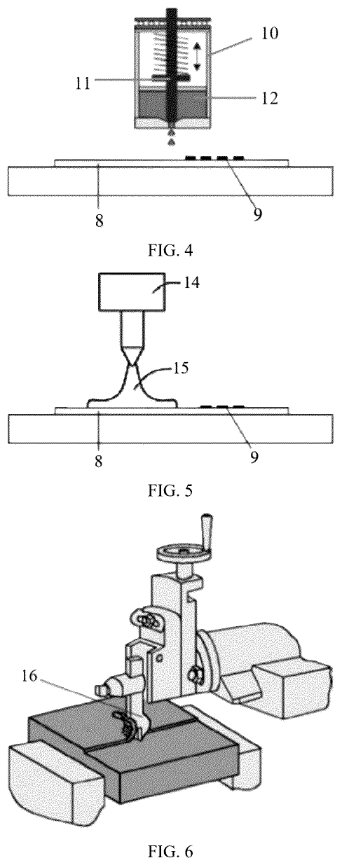

For each slice, a sacrificial material pattern layer is manufactured on a flat platform according to the slice pattern. This step can be achieved by various processes, for example, by a screen printing process. As shown in FIG. 3, on platform 8, sacrificial material slurry 4 is printed onto the platform through screen 6 consistent with the slice pattern by squeegee 5 to obtain sacrificial material pattern layer 9. Alternatively, as shown in FIG. 4, dispensing or jetting is performed through movable hopper 10 and control component 11 configured to control the opening and closing of a discharge port, depositing sacrificial material fluid 12 according to the pattern. The sacrificial material can be selected from a thermally sensitive material, such as paraffin wax, Fischer-Tropsch wax, or a low-melting-point alloy. The sacrificial material can also be a solvent-sensitive material, such as polyvinyl acetate (PVA) or a salt.

After the sacrificial material pattern layer 9 is formed on the platform 8, as shown in FIG. 5, spraying device 14 completely covers and encapsulates the pattern layer with mold material 15, and the mold material is cured to form an independent cured blank. The mold material can be selected from a high-temperature-resistant material that is stable in forming, such as a gypsum-based or cement-based composite material, or a mixture including ceramic powder and a binder.

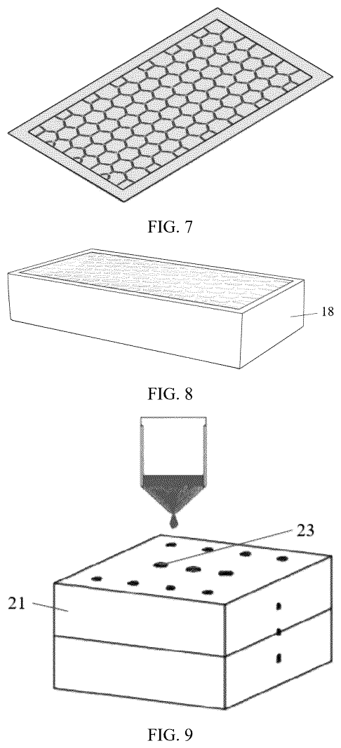

As shown in FIG. 6, precision machining device 16 (such as a milling machine or grinding machine) machines upper and lower reference surfaces of each cured blank to correct a thickness and flatness of the cured blank and remove an excess surface material. After machining, a series of finished mold units with highly precise dimensions are obtained, as shown in FIG. 7. Preferably, a thickness tolerance is controlled within ±0.02 mm.

As shown in FIG. 8, all units are precisely aligned and layered according to an original sequence, and bonded into a cured slice layer stack, thereby obtaining integrated combined mold 18.

The sacrificial material inside the integrated combined mold 18 is completely removed by means such as heating or solvent dissolution, thereby forming a precision cavity completely consistent with the target product inside the integrated combined mold.

As shown in FIG. 9, a material melt (such as molten metal) of a final product is injected from inlet channel 23 into the cavity of mold 21, and is cooled and solidified. The external mold material is removed by means such as breaking or dissolution, and a complete target 3D lattice component is obtained.

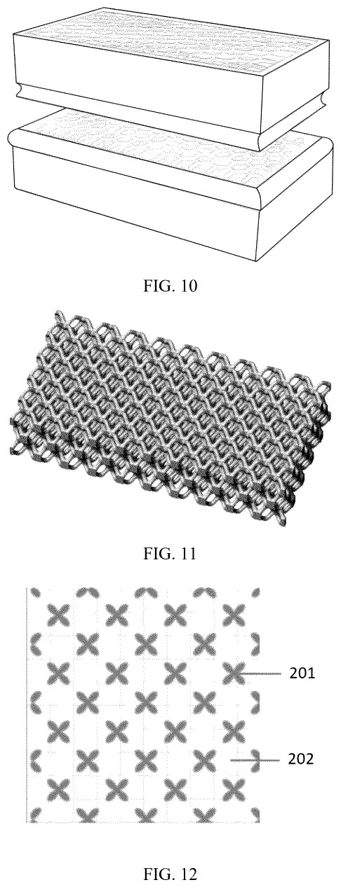

Furthermore, as shown in FIG. 10, multiple manufactured molds 21 can be assembled as sub-modules to form a composite mold for manufacturing an ultra-large-sized product, thereby breaking through the size limitations of a single manufacturing platform and manufacturing a larger-sized, more complex precision 3D component.

### Embodiment 2

In this embodiment, the manufacturing of a large-sized 3D lattice component shown in FIG. 1 is taken as an example to introduce another AM method. This embodiment adopts the idea of “mold creation first, followed by filling, and then machining” for manufacturing. As a target component, the 3D lattice component is integrally formed by multiple connection nodes and rod-shaped members connected together.

Specifically, the target component model shown in FIG. 1 is sliced to generate a series of positive patterns 201 and negative patterns 202 complementary to the positive patterns 201. The positive patterns 201 and the negative patterns 202 are shown in FIG. 12.

According to the negative patterns 202, multiple temporary mold units 208 are manufactured by an AM technology. Each unit has an internal cavity consistent with the shape of the corresponding positive pattern 201. The manufacturing method of the temporary mold units 208 can refer to the screen printing process and the dispensing or jetting process adopted in Embodiment 1.

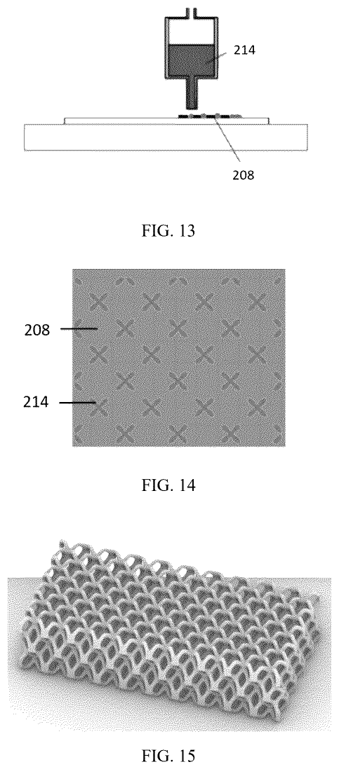

As shown in FIG. 13, final component material 214 (such as metal powder, ceramic slurry, or two-component resin) is filled into the cavity of each temporary mold unit 208 to form a filled unit blank.

Independent precision machining is performed on each filled unit blank to correct its thickness and flatness. Referring to the precision machining method adopted in Embodiment 1, the upper and lower reference surfaces of each cured unit blank are machined by the precision machining device 16 shown in FIG. 6 to correct the thickness and flatness of the cured unit blank and remove an excess surface material, thereby obtaining finished units shown in FIG. 14.

All the finished units are precisely aligned and stacked together according to the original slicing sequence.

The final component material 214 in adjacent units is cured and connected into an integral whole. For example, for metal powder, overall sintering is performed. For thermosetting resin, overall heat curing is performed.

The external temporary mold material is removed by means such as dissolution, heating, or mechanical peeling, thereby obtaining the final target component shown in FIG. 15.

When the final component material 214 is filled into the cavity of each temporary mold unit, a corresponding filling method is selected according to the physical form and flow characteristics of the final component material 214 to ensure uniform and complete filling within the negative pattern cavity of each mold unit. Movable powder materials are suitable for ceramic, metal, or plastic products requiring subsequent sintering or infiltration molding. Due to good fluidity, the powder can be filled into the mold unit from an opening through electrostatic/chemical/physical adsorption, pipe gravity conveying, or pneumatic/vacuum suction conveying. For fine structures, the filling density can be increased by vibration compaction. If the material is slurry, it is usually a mixture of powder and a binder, such as slurry including ceramic or metal powder mixed with an organic or inorganic binder. The slurry has high viscosity and is suitable for filling by screw pump pipe conveying or nozzle pressure feeding; it can also be filled in a vacuum environment to reduce bubble generation. For molten fluid (metal/plastic/ceramic melt) materials, they can be used to manufacture components requiring high strength or dense structures. The compatible filling methods include pressurized pipe pouring, nozzle spraying (suitable for thin layers or local repair), laser/plasma coating, and pouring method (gravity casting). For temperature-sensitive structures, segmented pouring+cooling control can be adopted. If the material is a fluid (such as two-component resin system or foam metal slurry) generated by a reaction, it is suitable for products that need to be cured in situ within the mold cavity, and it can be directly filled through a static mixing nozzle.

Different types of final component materials 214 are cured and form an integral whole between multiple independent units, and different adapted means can be adopted according to the materials. For thermally curable materials (such as thermosetting resin or metal brazing paste), after stacking is completed, unified heating is applied to cause chemical cross-linking or metallurgical bonding at the contact surfaces of the materials in adjacent units, thereby forming an integral seamless structure. For melt-solidification materials (such as thermoplastic plastics or low-melting-point metals), after combination, integral heating above the melting point is applied to melt and solidify the material at the contact surfaces, achieving metallurgical/physical welding. For sinterable powder materials (such as metal/ceramic powder), after combination, they can be put into a sintering furnace, and adjacent units are joined into one piece by high-temperature diffusion sintering. For reaction-curable materials (such as two-component slurry or foaming system), after combination, the material undergoes a chemical reaction at the contact surface, forming a continuous cured lattice structure. Furthermore, mechanical interlocking can be used to assist bonding, and interlocking structures are designed at the boundaries during unit design to enhance the overall connection strength in combination with the material during curing or sintering.

Efficient and non-destructive removal means can be selected according to the chemical composition and physical characteristics of the temporary material. For thermally sensitive materials (such as paraffin wax, low-melting-point alloys, or ice), heating and melting or direct sublimation are suitable for discharge, provided the target component material can withstand it. For example, paraffin wax can melt and flow out at 60-80° C., and ice can sublimate and be discharged directly under low-pressure conditions. For solvent-sensitive materials (such as PVA, soluble acrylic acid, sodium chloride), solvent immersion and dissolution can be used (PVA dissolves in warm water, and sodium chloride can be dissolved in deionized water), and ultrasonic vibration can be applied if necessary to accelerate the removal process. For thermally decomposable materials (such as specific organic polymers), thermal decomposition in a controlled atmosphere (such as heating in an inert atmosphere oven) can be utilized, ensuring that the byproducts are easily discharged without contaminating the target component. For mechanically separable materials (such as brittle plaster, low-strength composites), mechanical peeling or low-impact vibration crushing can be used for removal, which is suitable for components less sensitive to internal structure.

Additionally, preferably, the temporary mold units 208 and the target component have separable interface characteristics, making the removal operation easy to complete without damaging the target component. This separable interface characteristic can be achieved through material combination and/or surface treatment processes. Material combinations with low chemical compatibility can be chosen, i.e., temporary materials that show no tendency to form chemical bonds with the target component material after curing (e.g., paraffin wax mold and epoxy resin component). An interface isolation layer can be set by spraying or brushing a layer of release agent (such as polytetrafluoroethylene suspension, silicone oil, graphite coating) on the inner surface of the temporary mold unit before filling, forming a physically non-adhesive interface. It can be achieved through differences in surface microstructure, i.e., micro-texturing the surface of the temporary mold to reduce the contact area and increase the convenience of mechanical demolding. A controllably weak bond can also be designed, forming an easily breakable weak layer (such as a low-strength coating or disintegrable interface material) at the junction between the temporary mold and the final component, such that this part fractures preferentially during the removal step.

The above implementations are exemplary, aimed at illustrating the technical concept and features of the present disclosure such that those skilled in the art can understand the content of the present disclosure and implement it accordingly. They should not be construed as limiting the scope of protection of the present disclosure. Any equivalent change or modification in accordance with the spiritual essence of the present disclosure shall fall within the scope of protection of the present disclosure.

1. An additive manufacturing (AM) method based on modular precision mold units, comprising following steps:
a) slicing a digital model of a target three-dimensional (3D) component to generate a series of two-dimensional (2D) cross-sectional data;
b) manufacturing a series of physically separated mold unit blanks according to the 2D cross-sectional data, wherein each of the mold unit blanks comprises a pattern layer made of a sacrificial material and a mold material layer encapsulating the pattern layer;
c) performing precision machining on each of the mold unit blanks to achieve surface correction, and obtaining a series of finished mold units;
d) precisely aligning and stacking the series of finished mold units according to an original slicing sequence, and forming an integrated combined mold;
e) removing the sacrificial material from the integrated combined mold, and forming a mold cavity; and
f) introducing a material of the target component into the mold cavity for curing, removing the mold material after curing, and obtaining the target 3D component.

2. The AM method based on modular precision mold units according to claim 1, wherein the step c) comprises: performing precision machining on at least one reference surface on two sides of the mold unit blank to control flatness of the reference surface and/or a thickness of the mold unit blank.

3. The AM method based on modular precision mold units according to claim 2, wherein the precision machining is milling, grinding, planing, laser machining, plasma machining, or waterjet machining.

4. The AM method based on modular precision mold units according to claim 1, wherein the sacrificial material is a thermally sensitive material or a solvent-sensitive material.

5. The AM method based on modular precision mold units according to claim 4, wherein the thermally sensitive material is selected from water, paraffin wax, Fischer-Tropsch wax, polyethylene wax, or a low-melting-point alloy.

6. The AM method based on modular precision mold units according to claim 4, wherein the solvent-sensitive material is selected from a polyvinyl alcohol, a soluble acrylic resin, or a salt.

7. The AM method based on modular precision mold units according to claim 1, wherein the mold material is a high-temperature-resistant material selected from a gypsum-based composite material, a cement-based composite material, or a mixture comprising ceramic powder and a binder.

8. The AM method based on modular precision mold units according to claim 1, wherein the step b) comprises: forming the pattern layer made of the sacrificial material by a method selected from screen printing, inkjet printing, or fused deposition.

9. The method according to claim 1, wherein the target 3D component is a 3D component with an internal lattice structure.

10. The method according to claim 1, further comprising: assembling multiple integrated combined molds formed according to the step d) as sub-modules to form a larger composite mold for manufacturing the target 3D component exceeding a size range of a single integrated combined mold.

11. An AM method based on modular precision mold units, comprising following steps:
a) obtaining and slicing a digital model of a target 3D component into a series of 2D cross-sectional data;
b) manufacturing a series of layered temporary mold units according to the 2D cross-sectional data, wherein the temporary mold units are formed by depositing a temporary material on a flat substrate, and the deposited temporary material forms a negative pattern complementary in shape and consistent in contour with the 2D cross-sectional data;
c) filling a final component material into a negative pattern cavity of each mold unit;
d) performing independent precision machining on each mold unit filled with the final material to achieve thickness and flatness correction of the mold unit;
e) precisely aligning and stacking the precision-machined mold units according to an original slicing sequence;
f) curing the final component material, and connecting the final component material into an integrated whole; and
g) removing the temporary mold units to obtain the target 3D component.

12. The AM method based on modular precision mold units according to claim 11, wherein in the step c), the final component material is selected from flowable powder, slurry formed by mixing powder with a binder, a molten metal, plastic or ceramic fluid, or a reactively formable fluid.

13. The AM method based on modular precision mold units according to claim 12, wherein the final component material is filled by a method selected from pipe conveying, nozzle spraying, electrostatic, chemical or physical adsorption, or laser or plasma coating.

14. The AM method based on modular precision mold units according to claim 11, wherein the step g) comprises: selectively removing the temporary material under a preset condition selected from heating, cooling, dissolution, chemical reaction, or mechanical peeling.

15. The AM method based on modular precision mold units according to claim 11, wherein there is a separable interface characteristic between the temporary mold unit and the target component, enabling the removal of the temporary material to be completed without damaging the target component.
